(19) United States
(12) Patent Application Publication
(10) Pub. No.: US 2012/0241176 A1
(43) Pub. Date: Sep. 27, 2012

(54) APPARATUS AND METHOD OF SUPPORTING AND POWERING A MONITOR MOUNTED TO A MULTI-FLOOR PIPE APPARATUS

(75) Inventors: Steve Bollinger, Granger, IN (US); Curt McDowell, Goshen, IN (US); Bruce Behenna, LaPorte, IN (US)

(73) Assignee: ELKHART BRASS MANUFACTURING COMPANY, INC., Elkhart, IN (US)

(21) Appl. No.: 13/424,634

(22) Filed: Mar. 20, 2012

Related U.S. Application Data
(60) Provisional application No. 61/454,803, filed on Mar. 21, 2011.

(51) Int. Cl. A62C 3/00; A62C 31/28; A62C 2/00

(52) U.S. Cl. 169/46; 169/70; 169/25

(57) ABSTRACT

A system for use in a multi-story building is provided. The system may include a pipe apparatus having an inlet and an outlet. The inlet is coupled to a supply of fluid and the outlet directs the fluid. The system may include a frame assembly for supporting the pipe apparatus and enabling the inlet of the pipe apparatus to couple to the supply of fluid at a first floor of the building and enabling the outlet to deliver fluid to a higher floor of the building relative to the first floor. The system may include an electrically controlled fluid delivery device mounted at said outlet and in fluid communication with the pipe apparatus. The system may include a power supply having a power source located remotely from said electrically controlled fluid delivery device and supported by the frame assembly.

### RELATED APPLICATIONS

This application claims the benefit of U.S. Provisional Application Ser. No. 61/454,803, filed Mar. 21, 2011, titled AN APPARATUS AND METHOD OF SUPPORTING AND POWERING A MONITOR MOUNTED TO A MULTI-FLOOR PIPE APPARATUS, docket ELK01-P-351, the disclosure of which is expressly incorporated by reference.

### TECHNICAL FIELD

The present invention generally relates to an apparatus for supporting and delivering power to a monitor, which is mounted to the outlet end of a multi-floor pipe apparatus and, further, to a frame to support the multi-floor pipe apparatus.

### BACKGROUND

As described in U.S. Pat. No. 7,299,883, it is often difficult to extinguish fires in a multi-floor building where one or more floors in which the fire is located are inaccessible due to excessive heat or due to compromised flooring. To address this problem, the '883 patent describes a pipe apparatus that is supported on a frame, which allows the outlet end of the pipe apparatus to be extended through an opening in the building, such as a window, and then raised so that the outlet end of the pipe apparatus can direct water to a floor above where the frame is located.

### SUMMARY

In an exemplary embodiment of the present disclosure, a fire fighting system for use in a multi-story building is provided. The fire fighting system including a pipe apparatus having an inlet and an outlet, the inlet for coupling to a supply of fire fighting fluid, and the outlet for directing the fire fighting fluid; a frame assembly for supporting the pipe apparatus and enabling the inlet of the pipe apparatus to couple to the supply of fire fighting fluid at a first floor of the building and enabling the outlet to deliver fluid to a higher floor of the building relative to the first floor; an electrically controlled fluid delivery device mounted at said outlet and in fluid communication with the pipe apparatus; and a power supply having a power source, said power source being located remotely from the electrically controlled fluid delivery device and supported by the frame assembly and is proximate to the inlet of the pipe apparatus. In an example thereof, the power source is operatively coupled to the electrically controlled fluid delivery device to control an operation of the electrically controlled fluid delivery device. In another example thereof, the fire fighting system further comprises at least one electrical cord which operatively couples the power source to the electrically controlled fluid delivery device. In a variation thereof, the fire fighting system further comprises an extension arm coupled to the pipe apparatus, the extension arm including a conduit through which the at least one electrical cord passes. The pipe apparatus may include a first portion and a second portion which telescopes relative to the first portion resulting in the outlet being moveable relative to the input and the extension arm includes a telescoping portion. The conduit extending through the telescoping portion resulting in the at least one electrical cord passing through the telescoping portion. In another variation thereof, the fire fighting system further comprises an extension arm coupled to the pipe apparatus, the extension arm including a telescoping portion, and the at least one electrical cord passing through a conduit mounted to the telescoping portion. In a further example, the pipe apparatus is moveable relative to the frame assembly. In a variation thereof, the fire fighting system further comprises a plurality of bearings carried by the pipe apparatus which are received by a plurality of tracks carried by a plurality of guide members of the frame assembly, the plurality of bearings being located proximate a bend in the pipe apparatus. In a further variation thereof, the frame assembly further includes a pivot structure which is engaged by the bearings at a terminal end of the plurality of tracks such that when the plurality of bearings engage a portion of the pivot structure the pipe apparatus pivots relative to the frame assembly resulting in the outlet of the pipe apparatus being raised relative to the frame assembly. In still a further variation thereof, the pivot structure includes a lower ramped surface for guiding the plurality of bearings carried by the pipe apparatus and a generally vertically oriented portion which meets the lower ramped portion at a transition, the transition being the portion of the pivot structure. In another variation, the plurality of guide members and the pivot structure are steel metal components coupled together. In yet another example, a plurality of tips extend downward from the frame assembly, the plurality of tips being configured to reduce slippage of the frame assembly relative to a floor of the building. In still another example, the fire fighting system further comprises wheels which support the frame assembly, the wheels being moveable relative to the frame assembly between a deployed position and a stowed position. In yet still another example, the pipe apparatus is moveable relative to the frame assembly and the power supply is carried by the pipe apparatus. In a variation thereof, the fire fighting system further comprises an extension arm coupled to the pipe apparatus, wherein the pipe apparatus includes a first portion and a second portion which telescopes relative to the first portion resulting in the outlet being moveable relative to the input and the extension arm includes a telescoping portion, the power supply being carried by the extension arm. In a variation thereof, the power supply includes a housing including at least one electrical connector which are operatively coupled to the at least one electrical cord, the at least one electrical cord operatively coupling the power supply to the electrically controlled fluid delivery device. In a further variation thereof, the power source includes at least one electrical connector, the at least one electrical connector of the power source aligns with the at least one electrical connector of the housing. In still a further variation thereof, the housing includes an open end to receive the power source and an opening opposite the open end.

In another exemplary embodiment of the present disclosure, a method of fighting a fire in a multi-story building is provided. The method comprising the steps of supporting a fire fighting system at a first floor of the multi-story building; positioning an electronically controlled fluid delivery device proximate an exterior of the multi-story building at an opening in the exterior of the multi-story building corresponding to a second floor of the multi-story building; positioning a portable power source of the electronically controlled fluid delivery device below the second floor of the multi-story building, the second floor being above the first floor; and delivering a fire fighting fluid from an interior of the first floor of the multi-story building to the exterior of the building and then to the second floor of the multi-story building through the opening in the exterior of the multi-story building corresponding to the second floor of the multi-story building with the fire fighting system and the electronically controlled fluid delivery device. In an example thereof, the method further comprises the steps of providing a frame assembly supported by the first floor of the multi-story building; moveably coupling a pipe apparatus to the frame assembly, the pipe assembly being pivotable relative to the frame assembly to extend from the first floor of the multi-story building to the second floor of the multi-story building; and supporting the power source on the pipe assembly.

In a further exemplary embodiment of the present disclosure, a system for use in a multi-story building is provided. The system including a pipe apparatus having an inlet and an outlet, the inlet for coupling to a supply of fluid, and the outlet for directing the fluid; a frame assembly for supporting the pipe apparatus and enabling the inlet of the pipe apparatus to couple to the supply of fluid at a first floor of the building and enabling the outlet to deliver fluid to a higher floor of the building relative to the first floor; an electrically controlled fluid delivery device mounted at said outlet and in fluid communication with the pipe apparatus; and a power supply having a power source, said power source being located remotely from the electrically controlled fluid delivery device and supported by the frame assembly and is proximate to the inlet of the pipe apparatus. In one example, the power source is operatively coupled to the electrically controlled fluid delivery device to control an operation of the electrically controlled fluid delivery device. In another example, the system further comprises at least one electrical cord which operatively couples the power source to the electrically controlled fluid delivery device; and an extension arm coupled to the pipe apparatus, the extension arm including a conduit through which the at least one electrical cord passes, wherein the pipe apparatus includes a first portion and a second portion which telescopes relative to the first portion resulting in the outlet being moveable relative to the input and the extension arm includes a telescoping portion.

In still a further exemplary embodiment of the present disclosure, a method of providing a fluid in a multi-story building is provided. The method comprising the steps of supporting a system at a first floor of the multi-story building; positioning an electronically controlled fluid delivery device proximate an exterior of the multi-story building at an opening in the exterior of the multi-story building corresponding to a second floor of the multi-story building; positioning a portable power source of the electronically controlled fluid delivery device below the second floor of the multi-story building, the second floor being above the first floor; and delivering a fluid from an interior of the first floor of the multi-story building to the exterior of the building and then to the second floor of the multi-story building through the opening in the exterior of the multi-story building corresponding to the second floor of the multi-story building with the system and the electronically controlled fluid delivery device. In an example thereof, the method further comprises the steps of providing a frame assembly supported by the first floor of the multi-story building; moveably coupling a pipe apparatus to the frame assembly, the pipe assembly being pivotable relative to the frame assembly to extend from the first floor of the multi-story building to the second floor of the multi-story building; and supporting the power source on the pipe assembly.

The present disclosure provides a fire fighting system, which includes a pipe apparatus, a frame assembly for supporting the pipe apparatus and enabling the inlet of the pipe apparatus to couple to a supply of fire fighting fluid at a first floor of a building and enabling the outlet to deliver fluid to another location at a different floor than the first floor, and an electrically controlled fluid delivery device mounted at the outlet of the pipe apparatus. A power supply is provided that includes a power source operable to power the electrically controlled fluid delivery device, with power source located remotely from the electrically controlled fluid delivery device so that it is at or in close proximity to the inlet end of the pipe apparatus.

The frame assembly may be assembly from one or more metal blanks to provide a light weight frame that improves the portability of the system.

These and other objects, advantages, purposes, and features of the invention will become more apparent from the study of the following description taken in conjunction with the drawings.

### BRIEF DESCRIPTION OF THE DRAWINGS

FIG. 1 is a side elevation view of a multi-floor pipe apparatus and support frame therefor;

FIG. 2 is a side elevation view of the multi-floor pipe apparatus of FIG. 1, which incorporates a power supply system;

FIG. 3 is a similar view to FIG. 2 illustrating the pipe apparatus in an extended configuration;

FIG. 4 is a fragmentary enlarged cross-sectional view of the extension arm of the pipe apparatus forming a passageway for the power supply cable;

FIG. 5 is an exploded perspective view of the power supply system housing and battery;

FIG. 6 is an exploded perspective view of the frame of another embodiment of the support frame for the pipe apparatus;

FIG. 7 is a side elevation view of a frame with a retractable wheel in a deployed position;

FIG. 8 is a similar view to FIG. 7 illustrating the retractable wheel in a retracted position;

FIG. 9 is a representative view of the multi-floor pipe apparatus and support frame of FIG. 1 and a multi-story building.

### DETAILED DESCRIPTION OF THE PREFERRED EMBODIMENTS

The embodiments disclosed herein are not intended to be exhaustive or to limit the invention to the precise forms disclosed in the following detailed description. Rather, the embodiments are chosen and described so that others skilled in the art may utilize their teachings. While the present disclosure primarily involves the delivery of a fire fighting fluid to combat fires, it should be understood, that the invention may have application to other scenarios. In one embodiment, the systems and methods disclosed herein may be implemented to provide a fluid for neutralizing one or more chemical substances. For example, the systems and methods disclosed herein may be used to neutralize or otherwise alter chemicals used in explosives, drugs, or other items. Further, the systems and methods disclosed herein may be implemented to immobilize individuals.

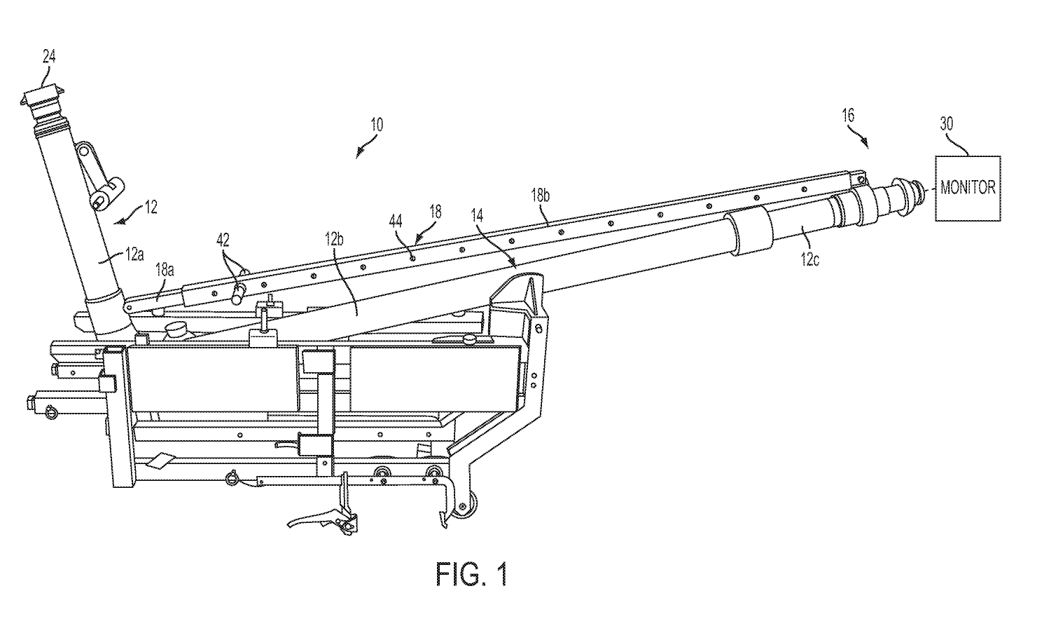

Referring to FIGS. 1-3, the numeral 10 generally designates a multi-floor firefighting system, which is adapted to direct the flow of water from one floor of a building to another floor of the building, as will be more fully described below. Multi-floor firefighting system 10 includes a multi-floor pipe apparatus 12 and a frame assembly 14. Frame assembly 14 supports pipe apparatus 12 and forms a guide for the pipe apparatus 12 and so that the pipe apparatus may be supported while it is pushed, for example to the right as viewed in FIG. 1, and guided so that the outlet end 16 of pipe apparatus 12 can be extended through an opening in the building, for example through a window, and then raised to direct firefighting fluid to the floor above. To increase the range of pipe apparatus 12, pipe apparatus 12 includes a telescoping portion that is extendible using an extendible arm 18. For further details of pipe apparatus 12, frame 14, and extension arm 18, reference is made to U.S. Pat. No. 7,299,883 and pending U.S. application Ser. No. 12/099,247 entitled APPARATUS AND METHOD FOR EXTINGUISHING FIRES IN A MULTI-FLOORED BUILDING, which are hereby incorporated in their entireties.

In order to increase the range, direction and/or control of the flow of firefighting fluid from the outlet end 16 of pipe apparatus 12, an electronically controlled fluid delivery device 30 may be mounted to the outlet end 16 of pipe apparatus 12. Exemplary electronically controlled fluid delivery devices include a nozzle or a monitor and nozzle. A monitor may increase the reach of the fluid flowing through pipe apparatus 12 and, further, provides enhanced control over the direction of flow from the outlet. Suitable nozzles and monitors are sold by Elkhart Brass Manufacturing Company, Inc. (Elkhart Brass) of Elkhart, Ind., with suitable monitors sold under the trademarks STINGER™ and SIDEWINDER® EXM available from Elkhart Brass. Exemplary electronically controlled monitors are disclosed in U.S. patent application Ser. No. 12/174,866, titled FIREFIGHTING DEVICE FEEDBACK CONTROL, the disclosure of which is expressly incorporated by reference herein.

In order to operate the power-operated actuators, such as motors 32, on the nozzle and/or monitor, power must be supplied to the actuator(s) 32 and control unit 34. However, locating a power supply at the nozzle or monitor potentially exposes the power source of the power supply to excessive heat and other detrimental environments and increases the effort to extend the pipe apparatus. Accordingly, the present invention provides a power supply system, illustratively a battery 20 that can deliver power to the monitor without subjecting the source of the power supply to the same environment as the monitor and/or nozzle and, moreover, that is accessible to the firefighter without putting the firefighter to greater risk of injury. For ease of description, the description hereafter references a monitor and nozzle application, but the invention is not so limited and also includes just the use of a nozzle or other fluid delivery devices. The illustrated battery 20 is an example of a portable power supply.

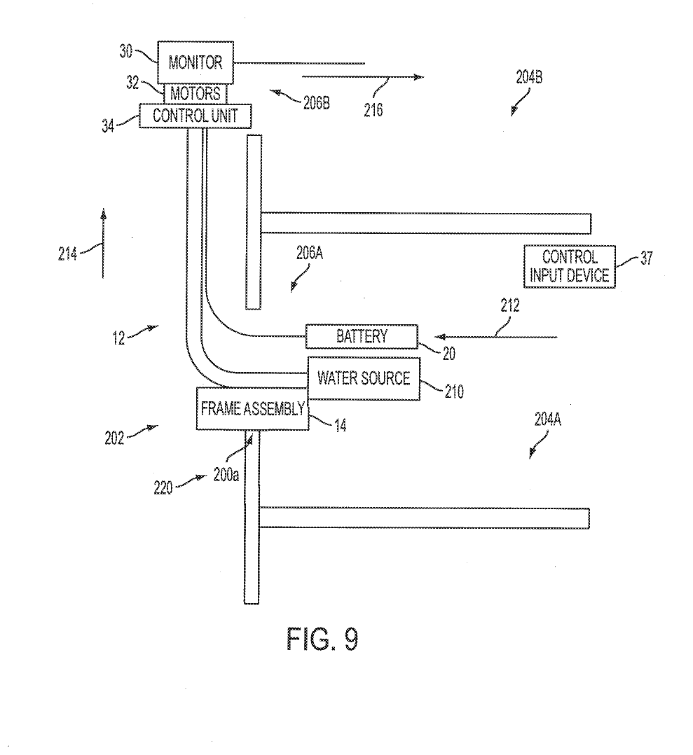

As shown in FIG. 9, multi-floor firefighting system 10 is shown with frame assembly 14 mounted to a window sill 200A of a building 202. Window sill 200A is part of a floor 204A of building 202 while a window sill 200B is part of a floor 204B of building 202. As illustrated in FIG. 9, floor 204B is positioned above floor 204A. In one embodiment, at least one additional floor is provided between floor 204A and floor 204B. In one embodiment, floor 204A and floor 204B are both above a ground floor level of building 202. Pipe apparatus 12 of multi-floor firefighting system 10 extends through an opening 206A of floor 204A of building 202 and electronically controlled fluid delivery device 30 is positioned adjacent an opening 206B of floor 204B of building 202. A supply of fire fighting fluid, illustratively a water source 210, is coupled to inlet 24 of pipe apparatus 12. Other fire suppression agents may be used instead of water.

Water source 210 provides water to pipe apparatus 12 which travels through pipe section 12A generally in direction 212. The water then travels upward in generally direction 214 and exits monitor 30 which is in fluid communication with the pipe apparatus 12 generally in direction 216 to combat a fire on floor 204B. An operator through control unit 34 may control motors 32 to adjust a nozzle of electronically controlled fluid delivery device 30 or to change an orientation of electronically controlled fluid delivery device 30 to direct the water in various directions. In one embodiment, an operator provides input signals to control unit 34 through a control input device 37. The control input device 37 may be a portable handheld device or attached to frame assembly 14. In one embodiment, the control input device 37 communicates with the control unit 34 over a wired connection. In one embodiment, the control input device 37 communicates with the control unit 34 over a wireless connection.

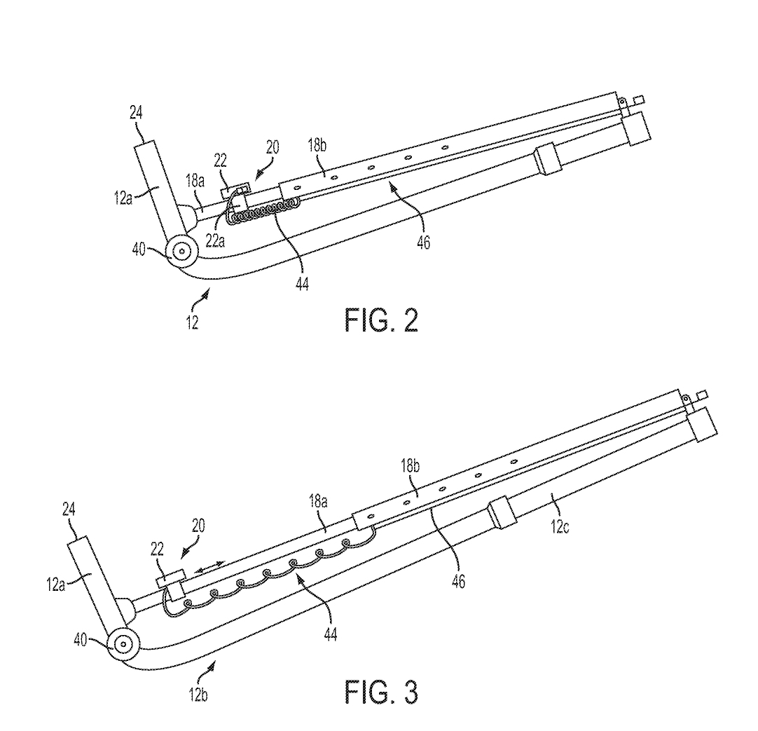

Referring to FIGS. 2 and 3, the power supply system includes a battery 20 and a housing 22, which is mounted to the extension arm 18 and which holds battery 20. In the illustrated embodiment, housing 22 is supported on the fixed end of the extension arm 18A adjacent its connection to inlet pipe section 12A, which forms inlet end 24 of pipe apparatus 12.

As described in the referenced application, pipe apparatus 12 has a curvilinear structure, which forms inlet 24 for receiving a fluid from a source of fluid pressure, and an intermediate portion 12B, which is located between the inlet 24 and outlet 16 and which is adapted to extend from a lower floor to an upper floor. Pipe apparatus 12 is formed from a rigid material, such as a metal material, including steel, stainless steel, or aluminum or an alloy thereof, but may also be produced from a polymeric material, such as polyvinyl chloride. Pipe apparatus 12 is generally formed from several pipe sections, which are joined end to end and, further as described, includes an extendible intermediate portion that includes a telescoping portion 12C, so that the length of the pipe apparatus 12 may be increased to extend the position of outlet 16.

Referring to FIGS. 1-3, as noted, pipe apparatus 12 also includes an extendible arm 18 with one end attached adjacent outlet 16 and the other end attached to inlet pipe section 12A. In addition to providing stiffness to pipe apparatus 12, extendible arm 18 retains the pipe apparatus in its desired length and, further, supports the telescoping portion 12C when it is extended.

As previously noted, frame 14 is adapted to support pipe apparatus 12 in a manner so that pipe apparatus 12 may be laterally guided and, further, may be pivoted to allow the outlet of the pipe apparatus to initially be extended through an opening in the wall of the building, for example through a window, and then raised so that it extends up to the floor above. As best seen in FIGS. 2 and 3, mounted to either side of the pipe apparatus is a pair of bearings, such as rollers 40, which are guided along tracks formed by a pair of rails in frame assembly 14. Rollers 40 are guided along the tracks to a terminal end of the tracks where continued forward movement of the pipe apparatus translates the motion into pivoting of the pipe apparatus to thereby raise the outlet 16. To facilitate the movement of the pipe apparatus along frame assembly 14, extension arm 18 includes a pair of transverse bars 42, which may be used as handles to push the pipe apparatus along the guide tracks provided by the rails.

To accommodate the extension of the pipe apparatus 12, extension arm 18 includes a fixed tubular member 18A and a telescoping tubular member 18 B, which can be fixed in position along member 18A to fix the length of intermediate pipe section 12 B by pins 44, which extend through transverse openings provided in tubular members 18A and 18 B. As previously noted, battery housing 22 is mounted to fixed tubular member 18A and further remote from outlet 16. In order to accommodate the extension of extension arm 18 (and the extension of the monitor mounted to outlet 16), the electrical cord that provides the connection between battery 20 and the monitor and nozzle motors may comprise a coiled electrical cord 44. Cord 44 may be routed through a conduit 46, which may be mounted to telescoping tubular member 18B or as noted below through extension arm 18.

Housing 22 may be fixedly mounted to tubular member 18A by a bracket 22A or may be movably mounted to tubular member 18A by a sleeve, such as a sleeve with low friction liner to allow movement of housing 22 along tubular member 18B when a sufficient force is applied. As best seen in FIGS. 2 and 3, housing 22 is mounted near or adjacent the proximal end of tubular member 18A to facilitate replacement of the battery when apparatus 12 is in use. When located at the proximal end of tubular member 18a, the housing and battery are either in the building or at least easily accessible from the building even when pipe apparatus 12 is extended from the building.

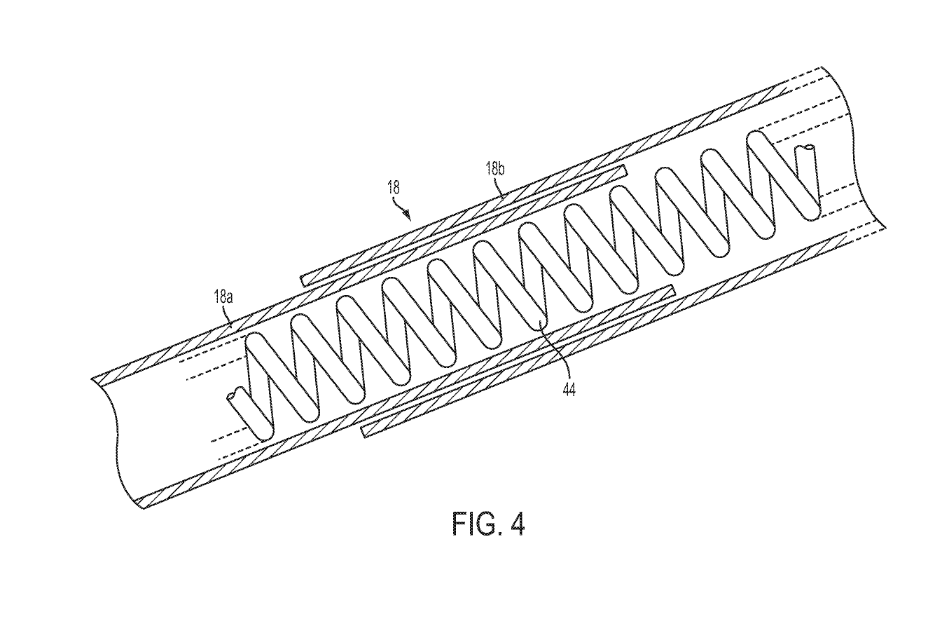

Referring to FIG. 4 alternately coiled electrical cord 44 may be extended through extension arm 18. The extension arm provides protection from the harsh environment and protection to the cable.

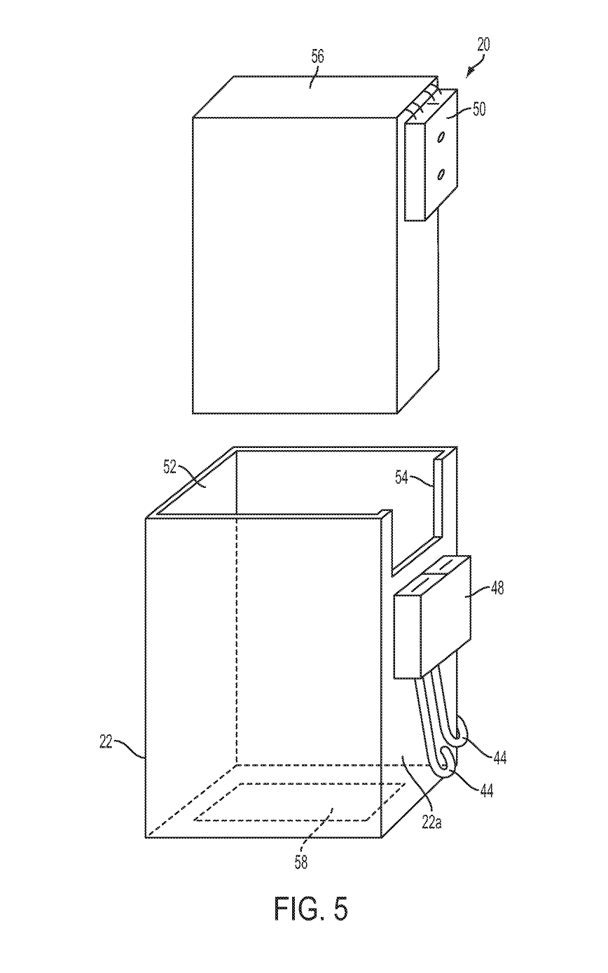

Referring to FIG. 5, battery housing 22 optionally incorporates one or more electrical connectors 48. Connectors 48 couple to the electrical cord (or cords) 44 and which correspond to and align with corresponding connectors 50 provided on battery 20 so that when battery 20 is inserted in housing 22, connectors 50 will mate with and connect to connectors 48 to provide automatic electrical connection of the battery to the power cord. Furthermore, connections 48 and 50 are configured to provide mechanical or frictional coupling between the respective connectors to retain the battery 20 in housing 22 when inserted.

In the illustrated embodiment, housing 22 includes an opening 52 on one end of the housing, which includes a recess 54 that extends into the side of housing 22. Positioned below recess 54 and mounted to the exterior surface 22A of housing 22 are connectors 48. Battery 20 similarly includes surface mounted connectors 50, which align with recess 54 when inserted into housing 22 so that connectors 50 can be aligned with and guided into connection with connectors 48. Furthermore, housing 22 is sized so that when battery 20 is inserted into housing, the upper end 56 of battery 20 is substantially flush with the end of housing 22. Optionally, the battery may incorporate a handle or an engagement structure to facilitate removal of the battery from the housing. Alternately, as shown, the battery may be ejected from the housing by way of an opening 58 provided at the opposed end of the housing, such as shown in FIG. 5. Opening 58 is sized large enough to allow a gloved hand to extend into the housing and push battery 20 from the opposed opening 52. When mounted to extension arm 18, the opening 58, for example may be oriented toward the inlet pipe section 12A to provide easy access to a firefighter.

As would be understood, by locating the battery at the proximal end of extension arm 18, the battery is located below and away from the high heat area when apparatus 10 is deployed in a firefighting situation. Furthermore, the location provides a firefighter easier access to the battery and reduces the force required to raise the pipe apparatus.

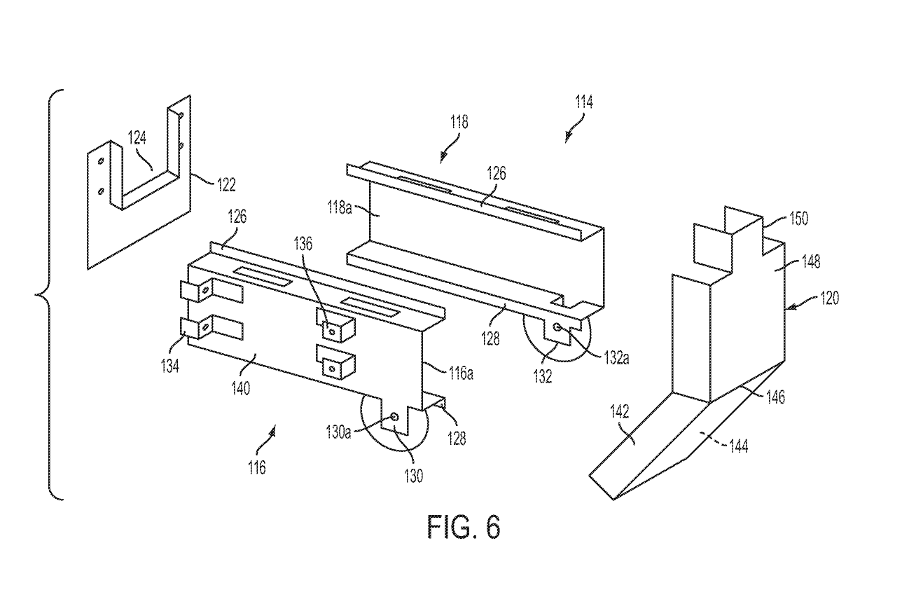

Referring to FIG. 6, the numeral 114 generally designates a multi-floor pipe apparatus support frame assembly. In one embodiment, frame assembly 114 is formed from a plurality of metal sheets that are stamped into a blank and assembled together, by a combination of folding portions of the blank and then securing some of them in place, by welding, bolting or riveting, to simplify the frame assembly and, further, to optionally reduce the weight of the frame assembly and increase the manufacturability. In one embodiment, additional non-sheet metal components may form part of frame assembly 114. It should be understood that apparatus 10 is often carried by one or more firefighters to a location in a building, which may require them to maneuver up several flights of stairs; therefore, weight is a significant consideration for such firefighting equipment.

As best seen in FIG. 6, frame assembly 114 includes a pair of rollers or bearing guides 116 and 118, a pivot structure 120, which joins guides 116 and 118 on one end, and a retaining member 122, which joins the other ends of guides 116 and 118 to form a frame. Retaining member 122 includes an opening 124 to form an entryway for the bearings or rollers (40) on pipe apparatus 12 into the guide tracks 116A and 118A formed by the guides 116 and 118. Pivot structure 120 provides a pivot surface for the rollers and a terminal end of the tracks so that when rollers reach pivot structure 120, forward motion of pipe apparatus 112 will be translated into pivoting and raising of the outlet 16.

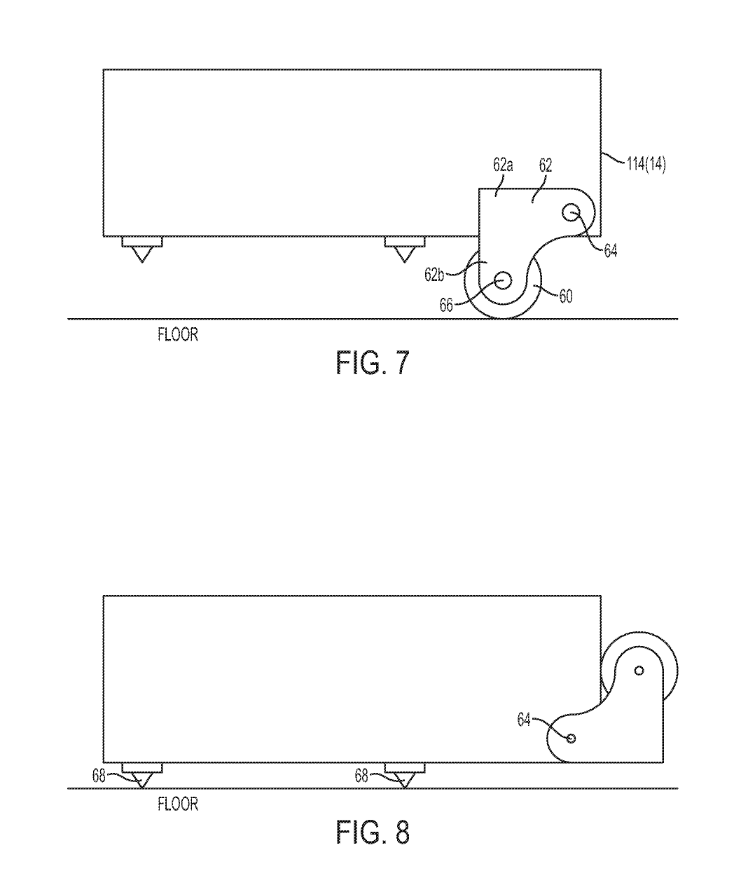

Each of the respective components 116, 118, 120, and 122 are stamped or otherwise cut from a sheet of metal, including aluminum or other metal sheet stock, which are then folded into the configurations as shown in FIG. 6. For example, the guide members 116 and 118 are folded into a channel-shaped configuration to form tracks 116A, 118A with a pair of upwardly and downwardly extending flanges 126 and 128, which may form additional guide surfaces for the pipe apparatus as it is moved along the guide path formed by guide tracks 116A and 118A. Cut out from the channel-shaped section at the pivot end of the frame are flanges 130 and 132, which include mounting openings 130A, 132A for receiving shafts of wheels or rollers or brackets such as described in reference to FIGS. 7 and 8. Optional additional intermediate cut-outs 134 and 136 may be provided in the web 140 of the channel-shaped section to provide mounting structures for anchoring stabilizing structure, such as described in U.S. Pat. No. 7,299,883 and pending U.S. application Ser. No. 12/099,247 entitled APPARATUS AND METHOD FOR EXTINGUISHING FIRES IN A MULTI-FLOORED BUILDING, which are hereby incorporated herein in their entireties, to anchor frame assembly 114 to the floor of a building. Further, additional cut-outs may be made to reduce the weight of frame assembly 114.

Pivot guide structure 120 is cut and folded together as shown in FIG. 6 to form a lower channel-shaped section 142, which is sized and arranged to join with the respective ends of the guide members 116 and 118. Lower channel-shaped section 142 forms a ramped surface 144 for guiding the rollers and, hence the pipe apparatus 12, upwardly until the rollers reach the transition 146 between the lower ramped surface 142 and the generally vertically oriented portion 148 of guide 120. Once the rollers reach transition 146, the intermediate pipe section 18 will pivot about rollers to raise the outlet of the pipe, which is guided through upper channel shaped member 150. As noted, the respective components of the frame assembly may be bolted together, riveted together, or welded and, further, may be reinforced using conventional techniques.

Referring to FIGS. 7 and 8, as previously noted, the frame assembly (114 or 14) may incorporate bearings, such as wheels 60, to facilitate the transportation of system 10. Further, wheels 60 may be provided that are retractable. In the illustrated embodiment, wheels 60 may be mounted to the frame assembly (114 or 14) by a generally L-shaped bracket 62, which is pinned on one leg by a pin 64 to frame assembly, and supports a shaft 66 of wheel 60 at its other leg 62B. When deployed, the wheels are generally located beneath the frame assembly (114 or 14) for engaging the ground or floor, but then can be pivoted along an accurate path about pins 64 to a stowed position to prevent the frame from moving when in use. For example, pins 64 may incorporate torsion control mechanisms, which limit free movement of the bracket 62 about pins 64 but allow rotation of the bracket when a sufficient force is applied.

To reduce slippage of the frame assembly (114 or 14), the frame assembly may incorporate pointed tips 68, which are mounted to the underside of the frame assembly that engage the floor or surface on which the apparatus is located. For example, suitable tips include carbide tips, which can extend through carpet or other floor coverings to engage the concrete or subfloor to prevent slippage of the frame assembly relative to the floor (or to a ground surface).

While several forms of the invention have been shown and described, other changes and modifications will be appreciated by those skilled in the relevant art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

1. A fire fighting system for use in a multi-story building, the fire fighting system including:
a pipe apparatus having an inlet and an outlet, the inlet for coupling to a supply of fire fighting fluid, and the outlet for directing the fire fighting fluid;
a frame assembly for supporting the pipe apparatus and enabling the inlet of the pipe apparatus to couple to the supply of fire fighting fluid at a first floor of the building and enabling the outlet to deliver fluid to a higher floor of the building relative to the first floor;
an electrically controlled fluid delivery device mounted at said outlet and in fluid communication with the pipe apparatus; and
a power supply having a power source, said power source being located remotely from the electrically controlled fluid delivery device and supported by the frame assembly and is proximate to the inlet of the pipe apparatus.

2. The fire fighting system of claim 1, wherein the power source is operatively coupled to the electrically controlled fluid delivery device to control an operation of the electrically controlled fluid delivery device.

3. The fire fighting system of claim 1, further comprising at least one electrical cord which operatively couples the power source to the electrically controlled fluid delivery device.

4. The fire fighting system of claim 3, further comprising an extension arm coupled to the pipe apparatus, the extension arm including a conduit through which the at least one electrical cord passes.

5. The fire fighting system of claim 4, wherein the pipe apparatus includes a first portion and a second portion which telescopes relative to the first portion resulting in the outlet being moveable relative to the input and the extension arm includes a telescoping portion, the conduit extending through the telescoping portion resulting in the at least one electrical cord passing through the telescoping portion.

6. The fire fighting system of claim 3, further comprising an extension arm coupled to the pipe apparatus, the extension arm including a telescoping portion, and the at least one electrical cord passing through a conduit mounted to the telescoping portion.

7. The fire fighting system of claim 1, wherein the pipe apparatus is moveable relative to the frame assembly.

8. The fire fighting system of claim 7, further comprising a plurality of bearings carried by the pipe apparatus which are received by a plurality of tracks carried by a plurality of guide members of the frame assembly, the plurality of bearings being located proximate a bend in the pipe apparatus.

9. The fire fighting system of claim 8, wherein the frame assembly further includes a pivot structure which is engaged by the bearings at a terminal end of the plurality of tracks such that when the plurality of bearings engage a portion of the pivot structure the pipe apparatus pivots relative to the frame assembly resulting in the outlet of the pipe apparatus being raised relative to the frame assembly.

10. The fire fighting system of claim 9, wherein the pivot structure includes a lower ramped surface for guiding the plurality of bearings carried by the pipe apparatus and a generally vertically oriented portion which meets the lower ramped portion at a transition, the transition being the portion of the pivot structure.

11. The fire fighting system of claim 9, wherein the plurality of guide members and the pivot structure are steel metal components coupled together.

12. The fire fighting system of claim 1, wherein a plurality of tips extend downward from the frame assembly, the plurality of tips being configured to reduce slippage of the frame assembly relative to a floor of the building.

13. The fire fighting system of claim 1, further comprising wheels which support the frame assembly, the wheels being moveable relative to the frame assembly between a deployed position and a stowed position.

14. The fire fighting system of claim 1, wherein the pipe apparatus is moveable relative to the frame assembly and the power supply is carried by the pipe apparatus.

15. The fire fighting system of claim 14, further comprising an extension arm coupled to the pipe apparatus, wherein the pipe apparatus includes a first portion and a second portion which telescopes relative to the first portion resulting in the outlet being moveable relative to the input and the extension arm includes a telescoping portion, the power supply being carried by the extension arm.

16. The fire fighting system of claim 15, wherein the power supply includes a housing including at least one electrical connector which are operatively coupled to the at least one electrical cord, the at least one electrical cord operatively coupling the power supply to the electrically controlled fluid delivery device.

17. The fire fighting system of claim 16, wherein the power source includes at least one electrical connector, the at least one electrical connector of the power source aligns with the at least one electrical connector of the housing.

18. The fire fighting system of claim 17, wherein the housing includes an open end to receive the power source and an opening opposite the open end.

19. A method of fighting a fire in a multi-story building, the method comprising the steps of:
supporting a fire fighting system at a first floor of the multi-story building;
positioning an electronically controlled fluid delivery device proximate an exterior of the multi-story building at an opening in the exterior of the multi-story building corresponding to a second floor of the multi-story building;
positioning a portable power source of the electronically controlled fluid delivery device below the second floor of the multi-story building, the second floor being above the first floor; and
delivering a fire fighting fluid from an interior of the first floor of the multi-story building to the exterior of the building and then to the second floor of the multi-story building through the opening in the exterior of the multi-story building corresponding to the second floor of the multi-story building with the fire fighting system and the electronically controlled fluid delivery device.

20. The method of claim 19, further comprising the steps of:
providing a frame assembly supported by the first floor of the multi-story building;
moveably coupling a pipe apparatus to the frame assembly, the pipe assembly being pivotable relative to the frame assembly to extend from the first floor of the multi-story building to the second floor of the multi-story building; and
supporting the power source on the pipe assembly.

21. A system for use in a multi-story building, the system including:
a pipe apparatus having an inlet and an outlet, the inlet for coupling to a supply of fluid, and the outlet for directing the fluid;
a frame assembly for supporting the pipe apparatus and enabling the inlet of the pipe apparatus to couple to the supply of fluid at a first floor of the building and enabling the outlet to deliver fluid to a higher floor of the building relative to the first floor;
an electrically controlled fluid delivery device mounted at said outlet and in fluid communication with the pipe apparatus; and
a power supply having a power source, said power source being located remotely from the electrically controlled fluid delivery device and supported by the frame assembly and is proximate to the inlet of the pipe apparatus.

22. The system of claim 21, wherein the power source is operatively coupled to the electrically controlled fluid delivery device to control an operation of the electrically controlled fluid delivery device.

23. The system of claim 21, further comprising
at least one electrical cord which operatively couples the power source to the electrically controlled fluid delivery device; and
an extension arm coupled to the pipe apparatus, the extension arm including a conduit through which the at least one electrical cord passes, wherein the pipe apparatus includes a first portion and a second portion which telescopes relative to the first portion resulting in the outlet being moveable relative to the input and the extension arm includes a telescoping portion.

24. A method of providing a fluid in a multi-story building, the method comprising the steps of:
supporting a system at a first floor of the multi-story building;
positioning an electronically controlled fluid delivery device proximate an exterior of the multi-story building at an opening in the exterior of the multi-story building corresponding to a second floor of the multi-story building;
positioning a portable power source of the electronically controlled fluid delivery device below the second floor of the multi-story building, the second floor being above the first floor; and
delivering a fluid from an interior of the first floor of the multi-story building to the exterior of the building and then to the second floor of the multi-story building through the opening in the exterior of the multi-story building corresponding to the second floor of the multi-story building with the system and the electronically controlled fluid delivery device.

25. The method of claim 24, further comprising the steps of:
providing a frame assembly supported by the first floor of the multi-story building;
moveably coupling a pipe apparatus to the frame assembly, the pipe assembly being pivotable relative to the frame assembly to extend from the first floor of the multi-story building to the second floor of the multi-story building; and
supporting the power source on the pipe assembly.
